(19) United States
(12) Patent Application Publication
(10) Pub. No.: US 2026/0299274 A1
(43) Pub. Date: Oct. 1, 2026

(54) METHOD AND APPARATUS FOR REALIZING ULTRA-HIGH-SPEED STRUCTURED ILLUMINATION MICROSCOPY

(71) Applicant: ZHEJIANG UNIVERSITY, HANGZHOU, Zhejiang Province (CN)

(72) Inventors: CUIFANG KUANG, HANGZHOU, ZHEJIANG PROVINCE (CN); SHUNYU XIE, HANGZHOU, ZHEJIANG PROVINCE (CN); YOUHUA CHEN, HANGZHOU, ZHEJIANG PROVINCE (CN); LIANG XU, HANGZHOU, ZHEJIANG PROVINCE (CN); XIANGDONG LIU, HANGZHOU, ZHEJIANG PROVINCE (CN); LEI MAO, HANGZHOU, ZHEJIANG PROVINCE (CN); XU LIU, HANGZHOU, ZHEJIANG PROVINCE (CN)

(21) Appl. No.: 18/881,290

(22) PCT Filed: Apr. 17, 2023
(86) PCT No.: PCT/CN2023/088709

§ 371 Date: Jan. 5, 2025

(30) Foreign Application Priority Data
Jul. 5, 2022 (CN) 202210791925.7

(51) Int. Cl. G02B 21/06; G01N 21/64; G02B 21/16; G02B 27/28; G02B 27/58; G02F 1/01; G02F 1/11

(52) U.S. Cl. CPC G02B 21/06; G01N 21/64; G02B 21/16; G02B 27/283; G02B 27/58; G02F 1/0136; G02F 1/11

(57) ABSTRACT

Disclosed in the present invention is a method for realizing ultra high-speed structured illumination microimaging, including 1) shaping an illuminating beam emitted by a light source to form an illuminating beam with uniformly distributed light intensity; 2) splitting the illuminating beam into a central interference light path and a plurality of interference sub light paths, each of the interference sub light paths having illumination interference fringes in different directions on a sample surface; 3) compensating an optical distance for each of the interference sub light paths, to enable optical distances of all the sub light paths to be the same, and light of each of the interference sub light paths is split into p polarized light and s polarized light; 4) combining a beam of the central interference light path with the p polarized light and the s polarized light of each of the interference sub light paths and illuminating the combined beam to a sample to form a structured illumination pattern; and 5) collecting fluorescence activated by the sample for microimaging. Further disclosed in the present invention is a device for realizing ultra high-speed structured illumination microimaging. The present invention can improve the modulation speed of the illuminating light greatly, so as to realize ultra high-speed structured illumination microimaging.

### TECHNICAL FIELD

The present invention belongs to the field of optical engineering, and particularly relates to a method and device for realizing ultra high-speed structured illumination microimaging.

### BACKGROUND TECHNOLOGY

The optical microimaging technology is a detection means for the microworld. Thanks to its non-contact and damage-free characteristics, optical microimaging technology is widely applied to biomedical research. However, the resolution of conventional optical microimaging methods cannot break through the diffraction limit, so that the conventional optical microimaging methods cannot be used to observe microstructures less than 200 nm.

The structured illumination microimaging is a super-resolution imaging technology, which modulates illuminating light to obtain a plurality of sample drawings under different illuminations and finally reconstruct a super-resolution image. The theoretical resolution limit of the structured illumination microimaging can reach half of the diffraction limit. Although the structured illumination microimaging technology can improve the resolution, it scarifies the imaging speed. A plurality of original pictures photographed under illuminating modulation are needed for reconstructing each super-resolution image. The ultimate imaging speed not only depends on the photographing and reading speeds of a camera, but also is limited by the modulation speed of the illuminating light.

In the field of structured illumination microimaging, conventional illuminating modulation modes include an optical grating mechanical moving mode, a spatial light modulator modulating mode, a galvanometer scanning mode, and the like, where the modulation speed of the optical grating mechanical moving mode is the lowest; the spatial light modulator modulating mode can be divided into two categories: a liquid crystal spatial light modulator (SLM) and a digital micro-mirror device (DMD), where the former is relatively low in speed and the latter is relatively low in diffraction efficiency; and the galvanometer scanning mode has the highest speed but cannot satisfy the KHz-level imaging speed.

A patent application with publication No. CN105487214A provides a fast three-dimensional super-resolution microimaging method, including converting a laser beam into linear polarized light after collimating the laser beam, performing phase modulation on the linear polarized light, converting the linear polarized light into circular polarized light and projecting the circular polarized light to a sample to be measured, and collecting signal light emitted by each scanning point of the sample to be measured; performing three-dimensional scanning on the sample, where the phase modulation includes primary phase modulation and secondary phase modulation, the primary phase modulation uses a spatial light modulator that performs phase modulation on an s light component of the linear polarized light and the second phase modulation uses a spatial light modulator that performs phase modulation on an p light component of the linear polarized light; and finally, obtaining a three-dimensional super-resolution image according to effective signal light intensity. Modulation of the illuminating light by using the spatial light modulator is relatively low in imaging speed.

A patent application with publication No. CN206848565U provides an optical focus enhancing system based on a digital mirror device. After a first optical fiber and a collimating lens are provided, a laser emits a beam, the beam is incident to the digital mirror device after being transmitted by the first optical fiber, a light trap is provided at an exit end next to the digital mirror device, a beam shrinking module is provided at an exit end on the front side of the digital mirror device, and a dichroscope is provided in front; the beam is reflected by the dichroscope and enters a microobjective through a scanning module to be focused, and an experimental sample is located on a focal plane of the microobjective; and fluorescence activated by the experimental sample passes through the microobjective and the scanning module and is received by a light intensity detection module through the dichroscope for light intensity detection. Modulation of the illuminating light by using the digital mirror device has the problem of a relatively low diffraction efficiency.

It can be seen that existing solutions have limitations. To realize ultra high-speed structured illumination microimaging, a brand new design and method is needed to meet a high-speed imaging demand.

### SUMMARY OF THE INVENTION

An object of the present invention is to provide a method for ultra high-speed structured illumination microimaging, which can improve the modulation speed of the illuminating light greatly, so as to realize ultra high-speed (KHz level) structured illumination microimaging.

A method for ultra high-speed structured illumination microimaging, including:
1) shaping an illuminating beam emitted by a light source to form an illuminating beam with uniformly distributed light intensity;
2) splitting the illuminating beam into a central interference light path and a plurality of interference sub light paths, each of the interference sub light paths representing illumination interference fringes in different directions on a sample surface;
3) compensating an optical distance for each of the interference sub light paths to enable optical distances of all the sub light paths to be the same, and light of each of the interference sub light paths is split into p polarized light and s polarized light;
4) modulating the p polarized light and the s polarized light of each of the interference sub light paths by an electrooptical modulator to maintain a phase difference between the p polarized light and the s polarized light, and then changing polarization directions of the p polarized light and the s polarized light with a half wavelength plate to enable the polarization directions of the p polarized light and the s polarized light to be consistent;
5) combining a beam of the central interference light path with the p polarized light and the s polarized light of each of the interference sub light paths and then illuminating the combined beam to a sample to form a structured illumination pattern; and
6) collecting fluorescence activated by the sample for microimaging.

In the present invention, by using the image acquisition module based on a high-speed rotating mirror for imaging, a plurality of images can be imaged by single exposure. The experimental picture is photographed at a high speed to match the speed of illuminating modulation.

Preferably, the illuminating beam is reflected and transmitted after passing through a polarization beam splitter, reflected light entering the central interference light path and a transmitted light path then being divided into a plurality of interference sub light paths in sequence.

In a specific embodiment, the light beam can be divided into three interference sub light paths or expanded into multiple interference sub light paths as needed, to realize a more particular structured illumination pattern, for example particular lattice illumination.

Preferably, the on and off of each of the interference sub light paths are selectively controlled; once an interference sub light path is gated, a picture is recorded; and after all the sub light paths are gated in sequence, a group of intact structured illumination images are obtained.

Preferably, the interference sub light paths are gated simultaneously, and beams of the interference sub light paths collectively interfere to generate a two-dimensional structured illumination pattern.

In the present invention, the light paths can be gated simultaneously, and energy of the light paths can be distributed at any proportion, so that beams of the sub light paths interfere jointly to generate a two-dimensional structured illumination pattern, rather than being limited to a one-dimensional optical grating illumination pattern.

The present invention further provides a device for realizing ultra high-speed structured illumination, including a light source emitting an illuminating beam and an image acquisition module that collects fluorescence emitted by a sample, and further including the following components arranged on an illuminating beam light path:
a first polarization beam splitter that splits the illuminating beam, where reflected light enters a central interference light path and transmitted light is split into a plurality of interference sub light paths in sequence;
a gating module corresponding to the plurality of interference sub light paths, configured to control a gating state of each of the interference sub light paths;
a second polarization beam splitter located on each of the interference sub light paths, and configured to split light of each of the interference sub light paths into p polarized light and s polarized light; and
a deflecting and beam combining module, configured to combine a beam of the central interference light path and the p polarized light and the s polarized light of each of the interference sub light paths; and
illuminate the combined beam to a sample to form a structured illumination pattern and activate fluorescence to image to the image acquisition module.

In the present invention, the illuminating laser generated by the light source is split into two beams through the first polarization light beamer, where one of the beams enters the central interference light path and the other beam is controllably gated by a plurality of gating modules, so that the plurality of interference sub light paths are on and off in sequence. In each interference sub light path, the beam will pass through a high-speed phase modulation device and an optical distance compensation system successively. The optical distance compensation system will compensate the optical distance differences between the central interference light path and the interference sub light paths, so as to maintain the coherence among all the four interference sub light paths. The high-speed phase modulation device converts the beam into equant s polarized light and p polarized light and enables the s polarized light and p polarized light to have a specified phase difference. The polarization beam splitter will separate these two polarized light and change the spatial angle of the beam in combination with the reflector and the half wavelength plate. The half wavelength plate plays a role of rotating the polarization directions of the two interference light, so as to enable the polarization directions of the two interference light to be consistent, so that the interference result of the two interference light has the maximum contrast ratio. All light passes through the beam combining imaging system after being combined and illuminate the sample surface to form the structured illumination pattern at the focal plane of the objective lens. The activated fluorescence will be reflected by dichroscope and is finally captured by the image high-speed acquisition module. Moreover, a 10:90 beam splitter will also reflect 10% of energy, and the reflected light will enter a spectrum observation path to form a spectrum image of an interfere plane on the camera through the lens for monitoring the interference beam.

Preferably, the following components are provided between the light source and the first polarization beam splitter in sequence: an acoustic optical modulator, configured to perform high-speed on-off control of the beam; a beam shaping module, configured to generate collimated light with uniformly distributed spatial intensity; and a beam shrinking module, configured to change the diameter of the beam, where the diameter of the beam accords with a working aperture of an electrooptical modulator.

Preferably, the gating module includes a polarization electrooptical modulator and a polarization beam splitter. The following components are provided on the central interference light path in sequence: a first phase electrooptical modulator, configured to modulate a phase of the beam; a first polarization modulator, configured to change a polarization direction of the beam; and a first beam expanding module, configured to expand the beam.

In the present invention, the gating states of the sub light paths are controlled at a high speed based on the electrooptical modulator, and the electrooptical modulator is used to modulate the phase of the interference beam at a high speed and controls the phase difference thereof to generate different illumination patterns, which breaks through the speed limitation of a common phase modulation means; by using linear polarized illumination, the polarization direction of the beam is modulated at a high speed by using the electrooptical modulator, and matched with the polarization beam splitter, on and off of the different sub light paths are controlled at a high speed.

The polarization electrooptical modulator can change the polarization direction of the light, so as to control the light to be transmitted or reflected at the polarization beam splitter. The reflected light will enter the first inference sub light path, and the transmitted light will enter the next gating module to be continuously divided into the second interference sub light path and the third interference sub light path.

Preferably, the following components are provided on each of the interference sub light paths in sequence: a first half wavelength plate, configured to change the polarization direction of the beam, wherein an s component and a p component of the beam are equal; a second phase electrooptical modulator, configured to modulate the phase of the beam, where the s component and the p component of the beam generate a relative phase difference; a second beam expanding module, configured to expand the beam; an optical distance compensation module, configured to compensate optical distance differences among the interference sub light paths; and a third polarization beam splitter, configured to split the beam into the p polarized light and the s polarized light.

In combination with the spatial angle of the interference beam, the polarization direction of the interference beam is changed by using the half wavelength plate to obtain the maximum interference contrast ratio, and all interference beams are subjected to optical distance difference correction through the optical distance compensation module.

Preferably, the p polarized light and the s polarized light enters the deflecting and beam combining module after passing through a second half wavelength plate, the deflecting and beam combining module is provided with reflector assemblies corresponding to the beam of the central interference light path, the p polarized light and the s polarized light, and the deflecting and beam combining module deflects all the interference beams and combines the beams spatially.

In the present invention, all light paths are finally combined to the same illumination path, and interference regions of the light paths are superposed. A fixed reflector set is used to control the spatial angle of the interference beam.

Further preferably, the combined beam is illuminated to the sample through an objective lens, the fluorescence activated by the sample is imaged to the image acquisition module, the image acquisition module comprises a rotating mirror and a camera, there are a plurality of imaging light paths behind the rotating mirror, and the fluorescence circularly passes through the plurality of imaging light paths in sequence to be finally imaged to different areas of the camera.

In the present invention, the gating module, the high-speed phase modulation device, and the high-speed camera are under coordinated control. Once a sub light path is gated, the high-speed phase modulation device of the sub light path completes a series of related phase modulations. Once the camera is changed, a picture is recorded in the high-speed camera. Then, another sub light path is gated, and a phase control operation and a camera photographing operation are repeated. After all the sub light paths are gated in sequence, a group of intact structured illumination images is captured by the camera. The above steps are repeated to obtain a plurality of groups of structured illumination images.

The image high-speed module performs scanning by using the high-speed rotating mirror to divide a target plane of the camera into a plurality of imaging regions, and a plurality of fluorescence images can be photographed by single exposure of the camera.

In the present invention, on the spectrum plane where the illuminating light is combined, a spatial filter can be provided to screen out light with the needed frequency level, thereby improving the contrast ratio of the final illumination pattern.

Compared with the prior art, the present invention has the following advantages:
1) The electrooptical modulator is used for polarization modulation to control the on and off of each sub light path, where the highest gating speed can reach hundreds of kHz;
2) The electrooptical modulator is used for phase modulation to realize ultra high-speed phase modulation of the interference beam, where the modulation speed can reach hundreds of kHz, which is far higher than that in the existing technical solution. The imaging speed of the whole system is no longer limited by illuminating modulation;
3) Fixed reflectors are used to control the angle of the interference beam, with higher stability;
4) The polarization direction of the interference beam is changed by using the half wavelength plate, so that the contrast ratio of the interference image is improved.
5) All illuminating beams are combined to share the same illuminating imaging light path;
6) The image high-speed acquisition module performs scanning by using the high-speed rotating mirror, and the plurality of images are recorded by single exposure, so that the acquisition speed can further be increased several times based on the maximum imaging speed of the camera.

### DETAILED DESCRIPTION OF THE DRAWINGS

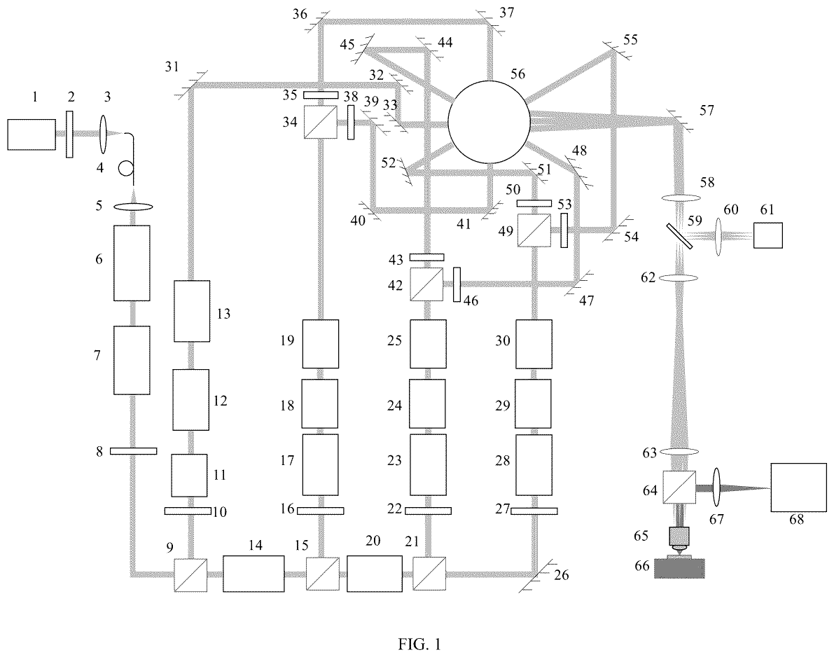

FIG. 1 is a light path diagram of a device for ultra highs-speed structured illumination microimaging in an embodiment of the present invention;

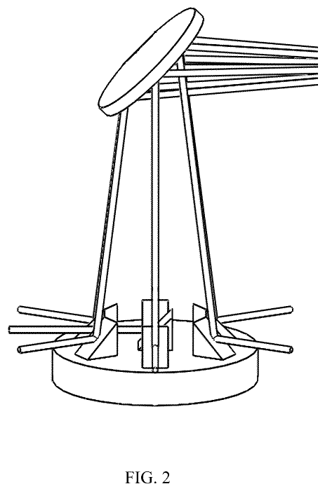

FIG. 2 is a schematic diagram of a deflecting and beam combining module in an embodiment of the present invention; and

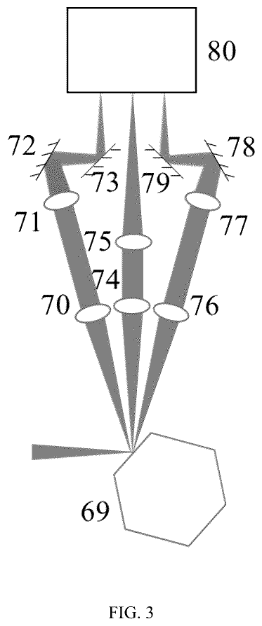

FIG. 3 is a schematic structural diagram of an image high-speed acquisition module in the present invention.

### DETAILED DESCRIPTION OF THE EMBODIMENTS

More specific details are described in the description below for the convenience of understanding the present invention fully. However, the present invention may further be implemented by other modes different from those described, such that the present invention is not limited to the specific embodiments disclosed below.

The embodiments of the present invention will be described in detail below, and an example of the embodiment is illustrated in the drawings, where the same or similar marks from all the way refer to same or similar components or components with same or similar functions.

A method for ultra high-speed structured illumination microimaging is realized as follows by using the device shown in FIG. 1:

A laser device 1 emits an illuminating beam, the illuminating beam is coupled to a single mode fiber 4 after passing through an acoustic optical modulator 2 and a first lens 3, and the acoustic optical modulator 2 can control the on and off of the beam at a high speed. Laser exits from the tail end of the single mode fiber 4 and becomes Gaussian collimated light after passing through a second lens 5. The collimated light passes through a beam shaping module 6 and becomes uniform flat top collimated light. Then the flat top collimated light is shrunk by a beam shrinking module 7. The diameter of the beam matches with an entrance aperture of each electrooptical modulator.

Before entering a first polarization beam splitter 9, the polarization direction of the beam is rotated by a first half wavelength plate 8, so that the light intensity is reflected and transmitted at a certain proportion after passing through the first polarization beam splitter 9. The partially reflected light will enter the central inference light path. The light entering the central inference light path passes through the second half wavelength plate 10, a first phase electrooptical modulator 11, and a first polarization electrooptical modulator 12. The beam is subjected to phase modulation by the first phase electrooptical modulator 11 and enters the first polarization electrooptical modulator 12, so that the polarization direction of the beam is changed. Then the beam is expanded by a first beam expanding module 13. The transmitted light after passing through the first polarization beam splitter 9 enters a second polarization electrooptical modulator 14 and is selectively converted into p polarized light (or s polarized light). The s polarized light will be reflected at a second polarization beam splitter 15 to enter the first interference sub light path and passes through a third half wavelength plate 16, a second phase electrooptical modulator 17, a second beam expanding module 18, and a first optical distance compensation module 19 in sequence. The third half wavelength plate 16 will change the polarization direction of the beam, where an s component and a p component of the beam are equal. Passing through the second phase electrooptical modulator, the s component and the p component of the beam generate a relative phase difference and then the beam is expanded by a second expanding module 18. The p polarized light modulated by the second polarization electrooptical modulator 14 will enter a third polarization electrooptical modulator 20 and is selectively converted into p polarized light (or s polarized light) again. Similarly, the s polarized light will enter the second interference sub light path and passes through a fourth half wavelength plate 22, a third phase electrooptical modulator 23, a third beam expanding module 24, and a second optical distance compensation module 25 in sequence, so that the s component and the p component of the beam are equal in intensity and have a constant phase difference. The p polarized light modulated by the third polarization electrooptical modulator 20 enters the third interference sub light path after being reflected by the first reflector 26, and passes through a fifth half wavelength plate 27, a fourth phase electrooptical modulator 28, a fourth beam expanding module 29, and a third optical distance compensation module 30 in sequence, so that the s component and the p component of the beam are equal in intensity and have a constant phase difference.

The first optical distance compensation module 19, the second optical distance compensation module 25, and the third optical distance compensation module 30 will compensate the optical distance differences among the interference light paths to enable the optical differences of all the interference beams to be within a laser coherent length.

Deflected by a second reflector 31, a third reflector 32, and a fourth reflector 33, the beam of the central interference light path is parallelly incident into the deflecting and beam combining module 56.

The light of the first interference sub light path is divided by the fourth polarization beam splitter 34 into p polarized light and s polarized light, where the p polarized light passes through a sixth wavelength plate 35, a fifth reflector 36, and a sixth reflector 37 to enter the deflecting and beam combining module 56, and the s polarized light passes through a sixth wavelength plate 38, a seventh reflector 39, an eighth reflector 40, and a ninth reflector 41 to enter the deflecting and beam combining module 56.

Similarly, the light of the second interference sub light path is divided by a fifth polarization beam splitter 42 into p polarized light and s polarized light, where the p polarized light passes through the eighth half wavelength plate 43, a tenth reflector 44, and an eleventh reflector 45 to enter the deflecting and beam combining module 56, and the s polarized light passes through the ninth half wavelength plate 46, a twelfth reflector 47, and a thirteenth reflector 48 to enter the deflecting and beam combining module 56.

Similarly, the light of the third interference sub light path is divided by a sixth polarization beam splitter 49 into p polarized light and s polarized light, where the p polarized light passes through the tenth half wavelength plate 50, a fourteenth reflector 51, and a fifteenth reflector 52 to enter the deflecting and beam combining module 56, and the s polarized light passes through the eleventh half wavelength plate 53, a sixteenth reflector 54, and a seventeenth reflector 55 to enter the deflecting and beam combining module 56.

The deflecting and beam combining module 56 will deflect all the interference beams at a proper angle and combine them spatially. The combined beam will be finally incident onto an eighteenth reflector 57. The combined beam passes through a 4f system consisting of a third lens 58 and a fourth lens 62 after being reflected, and has a plurality of interference levels in a Fourier plane of the 4f system. A 10:90 beam splitter 59 will reflect 10% of light and image the Fourier plane to a pupil plane monitoring camera 61 by using the fifth lens 63 to monitor a pupil plane. The residual 90% of energy will be illuminated to the sample through a field lens 63, a fluorescence module 64, and the objective lens 65 to form the structured illumination pattern. A three-dimensional translation sample stage can control the sample to translate three-dimensionally to realize transverse movement and axial scanning. Fluorescence activated by the sample will be reflected by the fluorescence module 64 and is imaged to high-speed acquisition module 68 through a sixth lens 67.

FIG. 2 is a schematic structural diagram of the deflecting and beam combining module 56. Seven tilting reflecting surfaces at special angles can reflect the incident seven beams (one central interference light and three pairs of sub interference light) at a certain angle and deflect the beams again through the reflector above to be combined.

FIG. 3 is a structural schematic diagram of the image high-speed acquisition module 68, including the high-speed rotating mirror 69, a seventh lens 70, an eighth lens 71, a nineteenth reflector 72, a twentieth reflector 73, a ninth lens 74, a tenth lens 75, an eleventh lens 76, a twelfth lens 77, a twenty-first lens 78, a twenty-second reflector 79, and the high-speed camera 80. The image plane of the sample and the reflecting surface of the high-speed rotating mirror are conjugated, and there are three imaging light paths behind the high-speed rotating mirror: a first imaging light path (the seventh lens 70, the eighth lens 71, the nineteenth reflector 72, and the twentieth reflector 73), a second imaging light path (the ninth lens 74 and the tenth lens 75), and a third imaging light path (the eleventh lens 76, the twelfth lens 77, the twenty-first lens 78, and the twenty-second lens 79). When the high-speed rotating mirror works, the fluorescence will circularly pass through the three imaging light paths in sequence to be finally imaged in different regions of the high-speed camera 80. In the time of single exposure of the high-speed camera 80, intact scanning is completed, and three experimental pictures are photographed, so that the acquisition speed is further increased to three times based on the highest photographing speed.

In other embodiment, the present invention further provides a method for ultra high-speed structured illumination microimaging, including:
1) shaping an illuminating beam emitted by a light source to form an illuminating beam with uniformly distributed light intensity;
2) splitting the illuminating beam into a central interference light path and a plurality of interference sub light paths, each of the interference sub light paths having illumination interference fringes in different directions on a sample surface;
3) compensating an optical distance for each of the interference sub light paths to enable optical distances of all the sub light paths to be the same, and light of each of the interference sub light paths is split into p polarized light and s polarized light;
4) combining a beam of the central interference light path with the p polarized light and the s polarized light of each of the interference sub light paths and then illuminating the combined beam to a sample to form a structured illumination pattern; and
5) collecting fluorescence activated by the sample for microimaging.

In the present invention, the method can be either realized based on the above device embodiment or implemented by light paths of other structures. Specifically, by using the image acquisition module based on a high-speed rotating mirror for imaging, a plurality of images can be imaged by single exposure. The experimental picture is photographed at a high speed to match the speed of illuminating modulation.

The illuminating beam is reflected and transmitted after passing through a polarization beam splitter, reflected light entering the central interference light path and a transmitted light path then being divided into a plurality of interference sub light paths in sequence.

In some other embodiments, the light beam can be divided into three interference sub light paths or expanded into multiple interference sub light paths as needed, to realize a more particular structured illumination pattern, for example particular lattice illumination.

In the embodiment, on and off of each of the interference sub light paths are selectively controlled; once an interference sub light path is gated, a picture is recorded; and after all the sub light paths are gated in sequence, a group of intact structured illumination images are obtained. Alternatively, the interference sub light paths are gated simultaneously, and beams of the interference sub light paths collectively interfere to generate a two-dimensional structured illumination pattern.

In the present invention, the light paths can be gated simultaneously, and the energy of the light paths can be distributed at any proportion, so that beams of the sub light paths interfere jointly to generate a two-dimensional structured illumination pattern, rather than being limited to a one-dimensional optical grating illumination pattern.

The above embodiments are preferred embodiments of the present invention and are not used to limit the present invention. Any modifications, equivalent replacements, improvements, and the like made within the spirit and principles of the present invention shall all fall within the scope of protection of the present invention.

What is claimed is:

1. A method for realizing ultra high-speed structured illumination microimaging, comprising:
1) shaping an illuminating beam emitted by a light source to form an illuminating beam with uniformly distributed light intensity;
2) splitting the illuminating beam into a central interference light path and a plurality of interference sub light paths, each of the interference sub light paths representing illumination interference fringes in different directions on a sample surface;
3) compensating an optical distance for each of the interference sub light paths to enable optical distances of all the sub light paths to be the same, and light of each of the interference sub light paths is split into p polarized light and s polarized light;
4) modulating the p polarized light and the s polarized light of each of the interference sub light paths by an electrooptical modulator to maintain a phase difference between the p polarized light and the s polarized light, and then changing polarization directions of the p polarized light and the s polarized light with a half wavelength plate to enable the polarization directions of the p polarized light and the s polarized light to be consistent;
5) combining a beam of the central interference light path with the p polarized light and the s polarized light of each of the interference sub light paths and then illuminating the combined beam to a sample to form a structured illumination pattern; and
6) collecting fluorescence activated by the sample for microimaging.

2. The method for realizing ultra high-speed structured illumination microimaging according to claim 1, wherein the illuminating beam is reflected and transmitted after passing through a polarization beam splitter, reflected light entering the central interference light path and a transmitted light path then being divided into a plurality of interference sub light paths in sequence.

3. The method for realizing ultra high-speed structured illumination microimaging according to claim 1, wherein on and off of each of the interference sub light paths are selectively controlled; once an interference sub light path is gated, a picture is recorded; and after all the sub light paths are gated in sequence, a group of intact structured illumination images are obtained.

4. The method for realizing ultra high-speed structured illumination microimaging according to claim 1, wherein the interference sub light paths are gated simultaneously, and beams of the interference sub light paths collectively interfere to generate a two-dimensional structured illumination pattern.

5. A device for realizing ultra high-speed structured illumination microimaging, comprising a light source emitting an illuminating beam and an image acquisition module that collects fluorescence emitted by a sample, and further comprising the following components arranged on an illuminating beam light path:
a first polarization beam splitter that splits the illuminating beam, wherein reflected light enters a central interference light path and transmitted light is split into a plurality of interference sub light paths in sequence;
a gating module corresponding to the plurality of interference sub light paths, configured to control a gating state of each of the interference sub light paths;
a second polarization beam splitter located on each of the interference sub light paths, and configured to split light of each of the interference sub light paths into p polarized light and s polarized light; and
a deflecting and beam combining module, configured to combine a beam of the central interference light path and the p polarized light and the s polarized light of each of the interference sub light paths; and
illuminate the combined beam to a sample to form a structured illumination pattern and activate fluorescence to image to the image acquisition module.

6. The device for realizing ultra high-speed structured illumination microimaging according to claim 5, wherein the following components are provided between the light source and the first polarization beam splitter in sequence:
an acoustic optical modulator, configured to perform high-speed on-off control of the beam;
a beam shaping module, configured to generate collimated light with uniformly distributed spatial intensity; and
a beam shrinking module, configured to change the diameter of the beam, wherein the diameter of the beam accords with a working aperture of an electrooptical modulator.

7. The device for realizing ultra high-speed structured illumination microimaging according to claim 5, wherein the following components are provided on the central interference light path in sequence:
a first phase electrooptical modulator, configured to modulate a phase of the beam;
a first polarization modulator, configured to change a polarization direction of the beam; and
a first beam expanding module, configured to expand the beam.

8. The device for realizing ultra high-speed structured illumination microimaging according to claim 1, wherein the gating module comprises a polarization electrooptical modulator and a polarization beam splitter, and the following components are provided on each of the interference sub light paths in sequence:
a first half wavelength plate, configured to change the polarization direction of the beam, wherein an s component and a p component of the beam are equal;
a second phase electrooptical modulator, configured to modulate the phase of the beam, wherein the s component and the p component of the beam generate a relative phase difference;
a second beam expanding module, configured to expand the beam;
an optical distance compensation module, configured to compensate optical distance differences among the interference sub light paths; and
a third polarization beam splitter, configured to split the beam into the p polarized light and the s polarized light.

9. The device for realizing ultra high-speed structured illumination microimaging according to claim 8, wherein the p polarized light and the s polarized light enters the deflecting and beam combining module after passing through a second half wavelength plate, the deflecting and beam combining module is provided with reflector assemblies corresponding to the beam of the central interference light path, the p polarized light and the s polarized light, and the deflecting and beam combining module deflects all the interference beams and combines the beams spatially.

10. The device for realizing ultra high-speed structured illumination microimaging according to claim 5, wherein the combined beam is illuminated to the sample through an objective lens, the fluorescence activated by the sample is imaged to the image acquisition module, the image acquisition module comprises a rotating mirror and a camera, there are a plurality of imaging light paths behind the rotating mirror, and the fluorescence circularly passes through the plurality of imaging light paths in sequence to be finally imaged to different areas of the camera.
